(19) United States
(12) Patent Application Publication
(10) Pub. No.: US 2010/0118067 A1
(43) Pub. Date: May 13, 2010

(54) WATER-SOLUBLE AZO COMPOUND OR SALT THEREOF, INK COMPOSITION AND COLORED PRODUCT

(76) Inventors: Ryoutarou Morita, Tokyo (JP); Yoshiaki Kawaida, Tokyo (JP)

Correspondence Address: Nields, Lemack & Frame, LLC, 176 E. Main Street, Suite #5, Westborough, MA, 01581, US

(21) Appl. No.: 12/451,071

(22) PCT Filed: May 7, 2008
(86) PCT No.: PCT/JP2008/058475

§ 371 Date: Oct. 23, 2009

(30) Foreign Application Priority Data
May 11, 2007 (JP) 2007-127437

(51) Int. Cl. B41J 29/38; B41J 2/175

(52) U.S. Cl. 347/9; 347/86; 347/100

(57) ABSTRACT

The present invention relates to a water-soluble azo compound represented by the following formula (1):

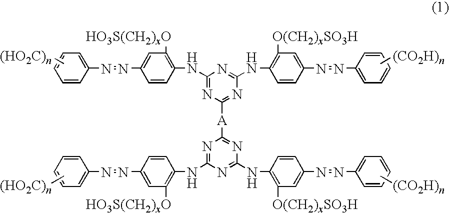

[wherein, n denotes 1 or 2, x denotes 2 to 4 and A denotes a divalent bonding group represented by one of the following general formulas (2) to (4):

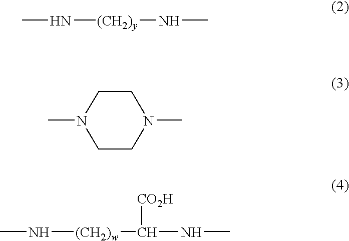

(Wherein, y denotes an integer number of 2 to 6 and w denotes an integer number of 1 to 4)]
or a salt thereof, and an ink composition containing it; it shows a hue having high vividness suitable for inkjet recording and provides a recorded matter having high water fastness, and the ink composition prepared using it is excellent in storage stability.

### TECHNICAL FIELD

The present invention relates to a water-soluble azo compound or a salt thereof, an ink composition containing the same and a colored product colored with the same.

### BACKGROUND ART

As for the recording method by means of an inkjet printer which is one of the typical methods among various color recording methods, various methods for discharging ink have been developed, and in any of the methods, ink droplets are generated and adhered onto various record-receiving materials (such as paper, film and cloth) to perform recording. This method has been rapidly prevailing lately and is expected to continue growing remarkably in the future because of features such as quietness without noise generation due to no direct contact of a recording head with a record-receiving material and as easiness in downsizing, speeding up and colorizing. Conventionally, as an ink for fountain pens, felt-tip pens or the like and as an ink for inkjet recording, inks where a water-soluble dye is dissolved in an aqueous medium have been used, and in these water-based inks, a water-soluble organic solvent is generally added to prevent ink from clogging at a pen tip or an inkjet nozzle. These inks are required to provide recorded images with sufficient density, not to clog at a pen tip or a nozzle, to dry quickly on a record-receiving material, to bleed less, to have excellent storage stability, and so on. In addition, recorded images formed are required to have fastnesses such as water fastness, moisture fastness, light fastness and gas fastness.

Clogging at the nozzle of an inkjet is often due that water in an ink evaporates in the vicinity of the nozzle before the other solvent and additive do, resulting in the compositional condition that water remains less while the other solvent and additive remain more whereby the coloring matter crystallizes and precipitates. Therefore, it is one of the very important performances required that crystals hardly precipitate even when the ink is dried by evaporation. In addition, for this reason, high solubility in solvents and additives is one of the properties required for coloring matters.

Meanwhile, in order that images or character information on a color display of a computer are recorded in color by an ink jet printer, subtractive color mixture of 4 color inks of yellow (Y), magenta (M), cyan (C) and black (K) is generally used, by which recorded images are expressed in color. In order that images by additive color mixture of red (R), green (G) and blue (B) on CRT (cathode ray tube) displays and the like are, as faithfully as possible, reproduced with images by subtractive color mixture, it is desired that coloring matters to be used for inks, particularly of Y, M and C, have respectively a hue close to each standard and also are vivid. In addition, it is required that the inks are stable in storage for a long period of time, and that images printed as the above have a high concentration and also the images are excellent in fastnesses such as water fastness, moisture fastness, light fastness, and gas fastness.

With the recent development of the inkjet techniques, improvement of inkjet printing speed is remarkable and there is a move to use an inkjet printer, as a laser printer using an electronic toner, for document printing on plain paper which is a major application in the office environment. The inkjet printer has some such advantages that there is no need to select the recording paper type and inkjet printers are inexpensive, and therefore it is becoming widespread particularly in small to medium scale office environments such as Small Office Home Office (SOHO). When an inkjet printer is thus used for application of printing on plain paper, there is a tendency that hue and water fastness are more emphasized among the qualities required for printed matters. In order to satisfy these performances, a method using a pigment ink has been proposed, but using a pigment ink poses such problems as stability thereof and clogging at the head nozzle. In addition, when a pigment ink is used, a problem often arises in abrasion resistance, too. Although it is said that dye inks relatively hardly pose such problems, in particular the water fastness thereof is extremely inferior compared with pigment inks, whereby improvement of water fastness thereof is strongly desired.

Many proposals have been made to the problem of improvement of water fastness on plain paper through the ages. As a yellow coloring matter for inkjet which is excellent in water fastness and whose hue and light fastness are improved, for example, a dye described in Patent Literature 1 is proposed.

### [Patent Literature 1] JP H4-233975 A

### DISCLOSURE OF THE INVENTION

### Problems to be Solved by the Invention

As for the dye described in Patent Literature 1, the water fastness thereof is very excellent against certain kinds of plain paper but it cannot be said that the high water fastness widely exerts the effect on many kinds of plain paper commercially available. In addition, the dye described in Patent Literature 1 has a problem that the color saturation as yellow when printed is low and thus the range of color to be exhibited is narrow particularly on plain paper. Therefore, development of a yellow coloring matter whose water fastness, color saturation, in addition, hue, print density and the like are further improved has been required.

It is an object of the present invention to provide a water-soluble yellow coloring matter (compound) which has a high solubility in water or a water-soluble organic solvent, a hue and a color saturation suitable for inkjet recording and a high color density and allows excellent fastnesses, such as light fastness, gas fastness, moisture fastness and particularly water fastness, of recorded matter, and to provide an ink composition containing it which has a good storage stability.

### Means of Solving the Problems

The present inventors have intensively studied to solve the above problems and found that a water-soluble tetraazo compound represented by a particular formula and an ink composition containing it can solve the above problems, and have completed the present invention.

That is, the present invention relates to:

(1) A water-soluble azo compound represented by the following formula (1) or a salt thereof:

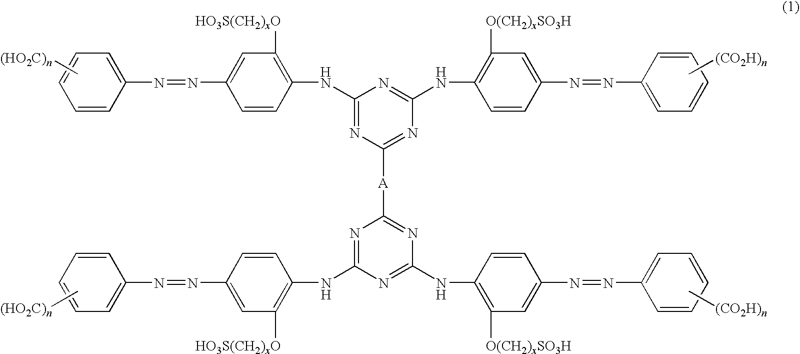

(wherein, n denotes 1 or 2, x denotes 2 to 4, and A denotes a divalent bonding group represented by any one of the following general formulas (2) to (4)),

### Formula (2):

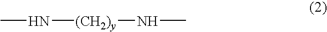

(wherein, y denotes an integer number of 2 to 6)

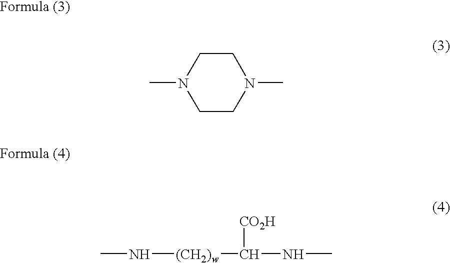

(wherein, w denotes an integer number of 1 to 4),
(2) The water-soluble azo compound or a salt thereof according to the above (1) represented by the following formula (5);

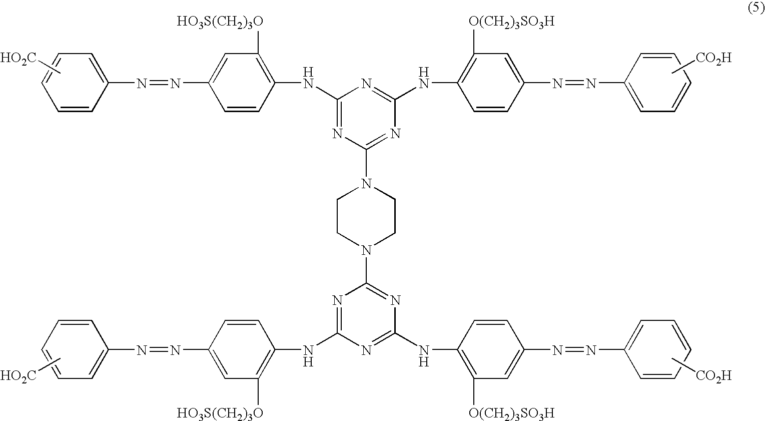

(3) An ink composition containing the water-soluble azo compound or a salt thereof according to the above (1) or (2),
(4) The ink composition according to the above (3), which contains a water-soluble organic solvent,
(5) The ink composition according to the above (3) or (4), which is for inkjet recording,
(6) An inkjet recording method characterized by discharging ink droplets of either (a) an ink composition containing the water-soluble azo compound or a salt thereof according to the above (1) or (2) or (b) an ink composition containing both the water-soluble azo compound or a salt thereof according to the above (1) or (2) and a water-soluble organic solvent, in response to a recording signal to record on a record-receiving material,
(7) The inkjet recording method according to the above (6), wherein the record-receiving material is a communication sheet,
(8) The inkjet recording method according to the above (7), wherein the communication sheet is a plain paper and a sheet having an ink receiving layer containing a porous white inorganic substance,
(9) A colored product colored with any of (a) the water-soluble azo compound or a salt thereof according to the above (1) or (2), or (b) an ink composition containing the water-soluble azo compound or a salt thereof according to the above (1) or (2), or (c) an ink composition containing both the water-soluble azo compound or a salt thereof according to the above (1) or (2) and a water-soluble organic solvent,
(10) The colored product according to (9), wherein coloring is performed by an inkjet printer,
(11) An inkjet printer comprising a container which is filled with either an ink composition containing the water-soluble azo compound or a salt thereof according to the above (1) or (2) or an ink composition containing both the water-soluble azo compound or a salt thereof according to the above (1) or (2) and a water-soluble organic solvent.

### EFFECT OF THE INVENTION

The water-soluble azo compound represented by the above formula (1) of the present invention or a salt thereof is excellent in solubility to water and water-soluble organic solvents. In addition, it has a characteristic of having a good filterability through, for example, a membrane filter in the process of producing the ink composition, and imparts a very vivid and highly bright yellow hue on plain paper and special paper for inkjet recording. Further, the ink composition of the present invention containing this compound is free from crystal precipitation and change in physical properties and hue after storage for a long period of time, and thus it has an extremely good storage stability. And, the printed matter recorded using the ink composition of the present invention as an ink for inkjet recording has an ideal hue as a yellow hue without selecting any record-receiving material (for example, paper, film and the like) and it can make it possible to faithfully reproduce photo-like color images on paper.

Furthermore, the ink composition of the present invention exhibits an extremely improved water fastness on plain paper compared with conventional dye inks. In addition, even when recording is performed on a record-receiving material coated with a porous white inorganic substance on the surface thereof, such as inkjet special paper for photo image quality or film, fastnesses i.e. water fastness, moisture fastness, gas fastness and light fastness thereof are good and the long-term storage stability of photo-like recorded images is excellent. Thus, the water-soluble azo compound of the formula (1) is useful as a yellow coloring matter and extremely useful as a yellow coloring matter for ink, particularly for inkjet recording ink.

### BEST MODE FOR CARRYING OUT THE INVENTION

The present invention will be specifically explained. In this connection, acidic functional groups such as a sulfo group and a carboxy group are shown in free acid form unless otherwise noted in the present description.

In addition, hereinafter in the present description unless otherwise noted, “the water-soluble azo compound of the present invention or a salt thereof” or “the compound the present invention” is referred to as “the coloring matter of the present invention” or optionally as only “the coloring matter”, for convenience.

The coloring matter of the present invention is represented by the above formula (1).

In the formula (1), n denotes 1 or 2, x denotes 2 to 4, and A denotes a divalent bonding group represented by any one of the above formulas (2) to (4).

In the formula (1), n represents 1 or 2 and is preferably 1. In addition, the substitution position of a carboxy group represented by —(CO₂H)ₙ can be any of the ortho-position, the meta-position and the para-position to the azo group, and the meta-position is more preferable.

x represents 2 to 4 and is preferably 3.

When A in the above formula (1) is the above formula (2), y in the formula (2) denotes an integer number of 2 to 6. Preferable thereof is 2 to 4 and particularly preferable is 2.

When A in the above formula (1) is the above formula (4), w in the formula (4) denotes an integer number of 1 to 4. Preferable thereof is 3 or 4.

As A in the above formula (1), the above formula (3) is more preferable among the above formulas (2) to (4).

In addition, the combination of a preferable one of any one of the above n, x and A with the others is preferable, a compound in combination of preferable ones of any two thereof is more preferable, and a compound in combination of preferable ones of the three is the most preferable.

Among the above combinations, the compound of the above formula (1) in the particularly preferable combination is a compound of the above formula (5).

The compound of the above formula (1) exists as a free acid or also as a salt thereof. The salt of the compound of the above formula (1) includes salts with an inorganic or organic cation. Specific examples of the salt with an inorganic cation include alkali metal salts such as salts, for example, lithium salt, sodium salt, potassium salt and the like. In addition, the salt with an organic cation includes salts of a compound represented by the following formula (6), but the salt is not limited thereto.

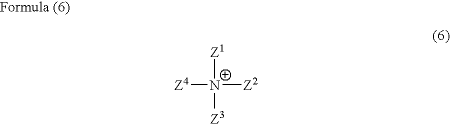

(wherein each of Z¹ to Z⁴ independently represents a hydrogen atom, a (C1 to C4) alkyl group, a hydroxy (C1 to C4) alkyl group or a hydroxy (C1 to C4) alkoxy (C1 to C4) alkyl group.)

Herein, examples of the above alkyl group for Z¹ to Z⁴ include methyl, ethyl and the like, and also examples of the above hydroxy alkyl group include hydroxymethyl, hydroxyethyl, 3-hydroxypropyl, 2-hydroxypropyl, 4-hydroxybutyl, 3-hydroxybutyl, 2-hydroxybutyl and the like, and in addition, examples of the above hydroxyalkoxyalkyl group include hydroxyethoxymethyl, 2-hydroxyethoxyethyl, 3-(hydroxyethoxy)propyl, 3-(hydroxyethoxy)butyl, 2-(hydroxyethoxy)butyl and the like.

Preferable salts among the above salts include salts with sodium, potassium, lithium, monoethanolamine, diethanolamine, triethanolamine, monoisopropanolamine, diisopropanolamine or triisopropanolamine, and ammonium salts. Among them, more preferable are lithium salts, sodium salts and ammonium salts.

As is clear to those skilled in the art, the salt of the compound of the above formula (1) can be easily obtained by the following method or the like.

For example, it is possible to obtain a sodium salt of the compound of the above formula (1) as a wet cake by adding sodium chloride to the reaction liquid before the addition of 800 parts of acetone in Example 1 described later or to the aqueous solution dissolving a wet cake containing the compound of the formula (1) or a dried form of the compound of the formula (1) for salting out, followed by filtration of the precipitated solid.

In addition, it is also possible to obtain a free acid of the compound of the above formula (1) or a mixture of free acid and sodium salt where some of the compound of the formula (1) is sodium salt by dissolving the wet cake of the obtained sodium salt and then adding an acid such as hydrochloric acid to appropriately adjust the pH, followed by filtration of the precipitated solid.

Further, it is also possible to obtain a potassium salt, a lithium salt, an ammonium salt or a salt of quaternary ammonium corresponding to the compound to be added, by that while stirring the wet cake of free acid of the compound of the formula (1) with water, for example, a potassium hydroxide, a lithium hydroxide, ammonia water or a hydroxide of the formula (6) was added to make the mixture alkaline. It is also possible to prepare, for example, a mixed salt of lithium salt and sodium salt, and in addition, a mixed salt of lithium salt, sodium salt and ammonium salt, or the like by controlling the number of moles of the above salt to be added relative to the number of moles of the free acid. As for the salt of the compound of the above formula (1), the physical properties thereof such as solubility or the ink performance when used as an ink may be changed according to the kind of the salt. For this reason, it is also preferred to select the kind of salt in accordance with the desired ink performance.

Among these salts, particularly preferable are lithium salt, sodium salt and ammonium salt as described above.

The coloring matter represented by the above formula (1) of the present invention can be produced as, for example, described below. In this connection, each of n, w, x and y which are appropriately used in the following formulas (A) to (H) has the same meaning as in the above formula (1).

A compound of the following formula (A) obtained by reference to the examples described in JP 2004-75719 A is converted to a methyl-ω-sulfonic acid derivative (B) by using sodium bisulfite and formalin. And then, the compound of the following formula (D) can be obtained by diazotizing an aminobenzene carboxylic acid represented by the following formula (C) using a conventional method, by carrying out coupling reaction with the methyl-ω-sulfonic acid derivative of the formula (B) obtained above at 0 to 15° C. and pH 6 to 7, and subsequently by carrying out hydrolyzation reaction at 80 to 95° C. and pH 10.5 to 11.5.

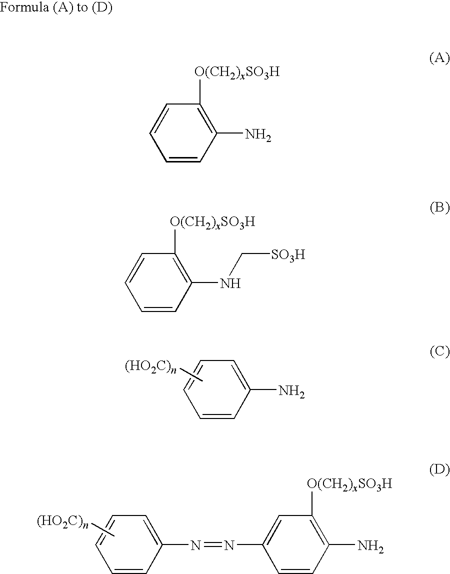

Next, the compound of the following formula (E) can be obtained by condensation of the compound (2 equivalents) of the above formula (D) and cyanuric halide, for example, cyanuric chloride at a temperature 25 to 45° C. and pH 5 to 7.5.

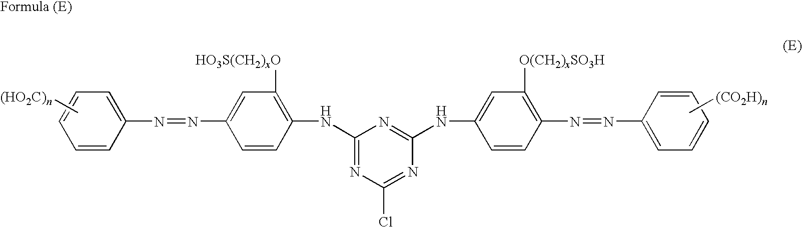

Further, the coloring matter of the present invention represented by the above formula (1) can be obtained by substituting the chlorine atom in the obtained compound of the above formula (E) with a compound represented by one of the following formulas (F) to (H), preferably under the conditions of 75 to 90° C. and pH 7 to 9.

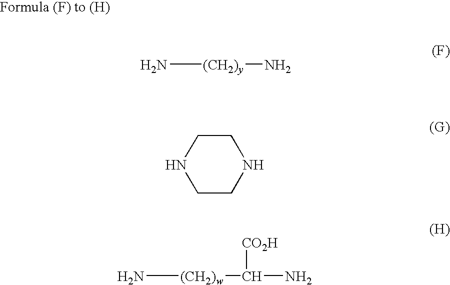

Specific examples of the compound of the above formula (A) include 2-sulfoethoxyaniline, 2-sulfopropoxyaniline and 2-sulfobutoxyaniline, and specific examples of the compound of the above formula (C) include, for example, 4-aminobenzoic acid, 3-aminobenzoic acid, 2-aminobenzoic acid, 5-aminoisophthalic acid, 2-aminoterephthalic acid and the like.

In addition, the compound of the above formula (F) includes ethylenediamine, hexamethylene diamine and the like, the compound of the formula (G) includes piperazine, and further, specific examples of the compound of the above formula (H) include 2,3-diaminopropionic acid, 2,4-diaminobutyric acid, 2,5-diaminovaleric acid and 2,6-diaminohexanoic acid.

Next, specific examples of the coloring matter of the present invention are shown in the following Table 1. In Table 1, acids such as carboxy and sulfo are shown in free acid form.

TABLE I

| Com- | | | | |
|---|---|---|---|---|
| pound | Structural Formula | | | |
| No. | n | x | A | |
| 1 | 1 | 2 | Formula (2) y = 2 | 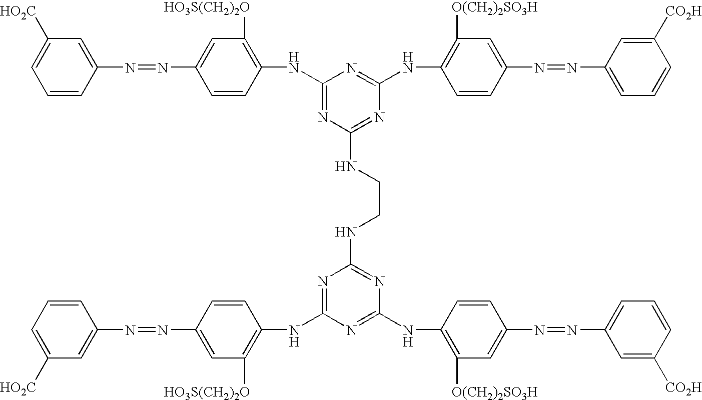 |
| 2 | 1 | 3 | Formula (2) y = 2 | 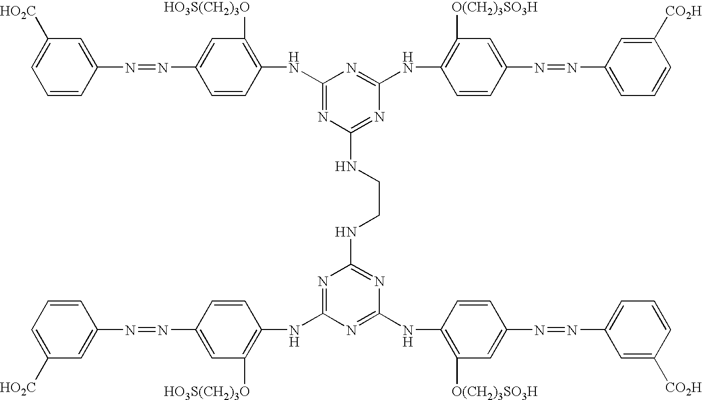 |
| 3 | 1 | 4 | Formula (2) y = 2 | 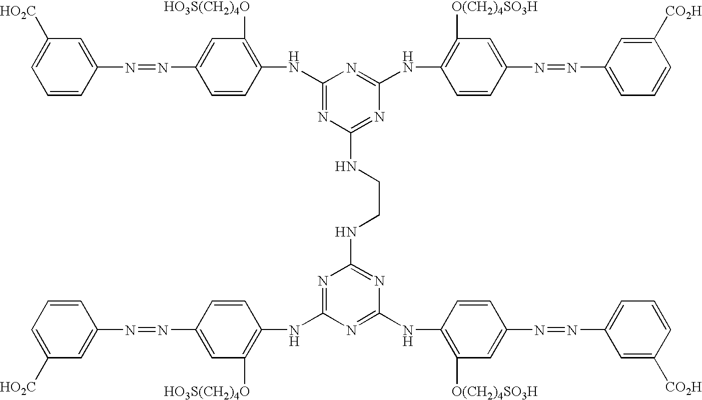 |
| 4 | 1 | 3 | Formula (2) y = 2 | 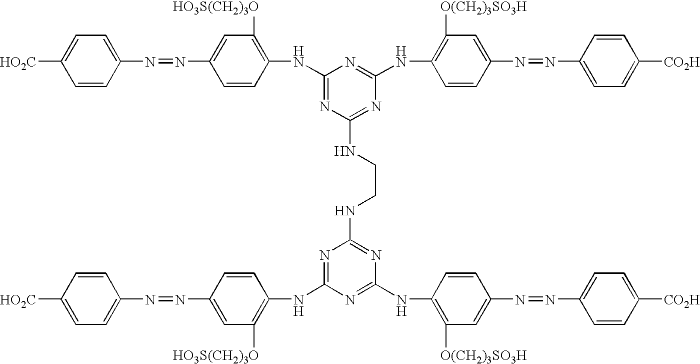 |
| 5 | 1 | 3 | Formula (2) y = 2 | 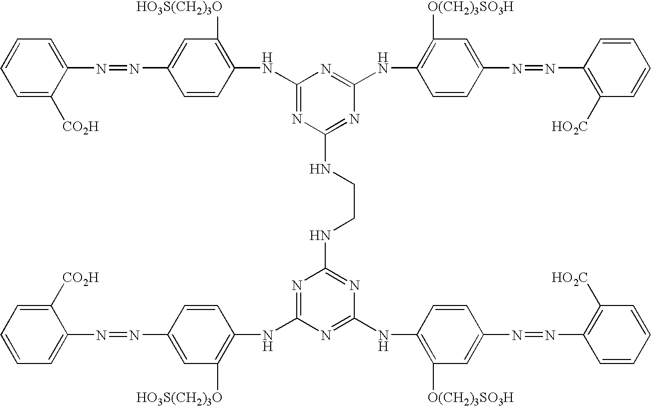 |
| 6 | 2 | 3 | Formula (2) y = 2 | 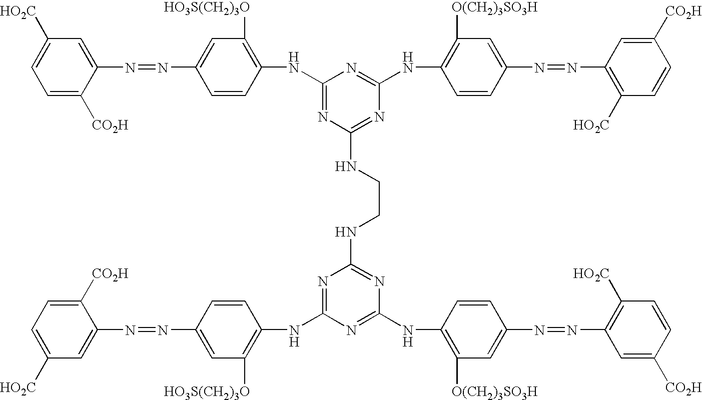 |
| 7 | 2 | 3 | Formula (2) y = 2 | 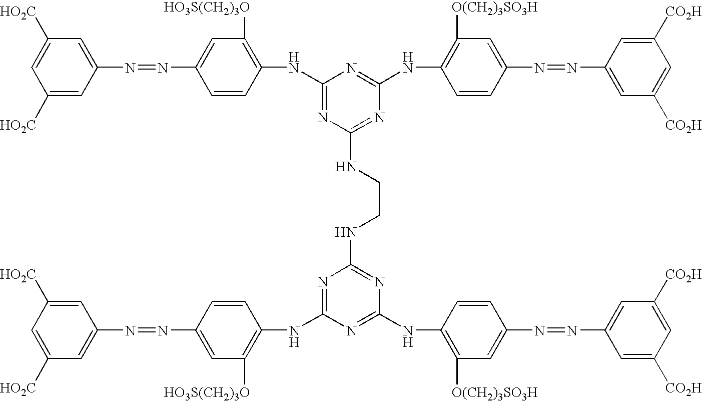 |
| 8 | 1 | 3 | Formula (2) y = 4 | 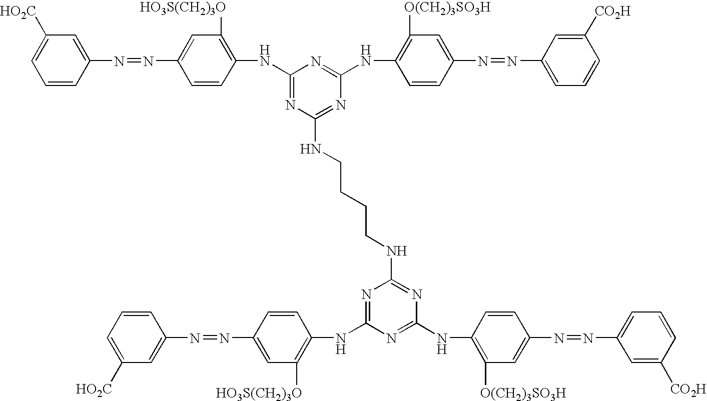 |
| 9 | 1 | 3 | Formula (2) y = 6 | 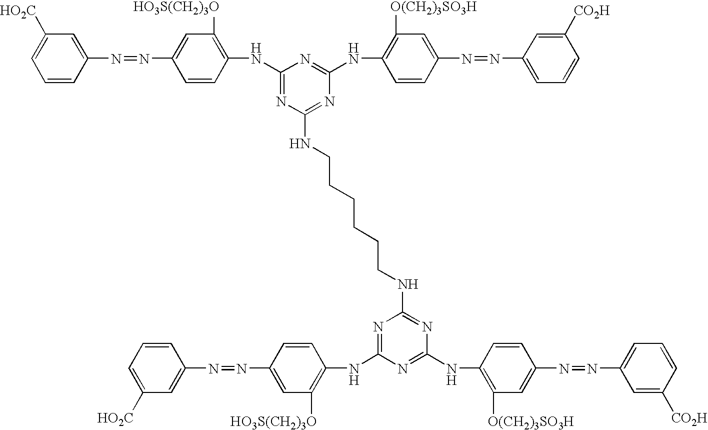 |
| 10 | 1 | 2 | Formula (3) | 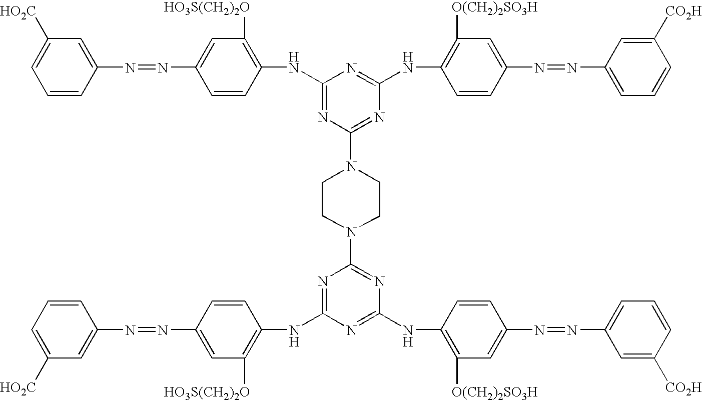 |
| 11 | 1 | 3 | Formula (3) | 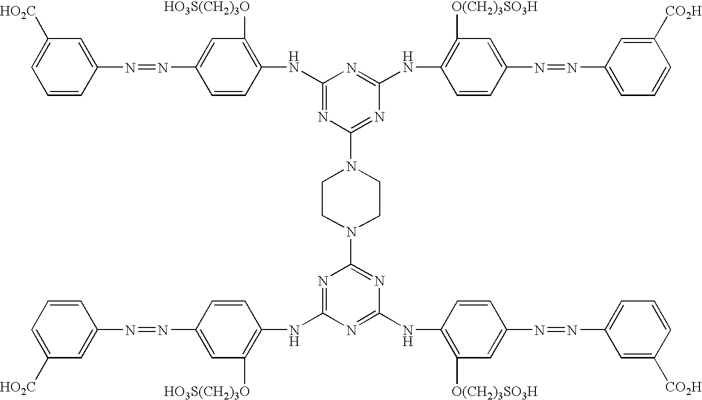 |
| 12 | 1 | 4 | Formula (3) | 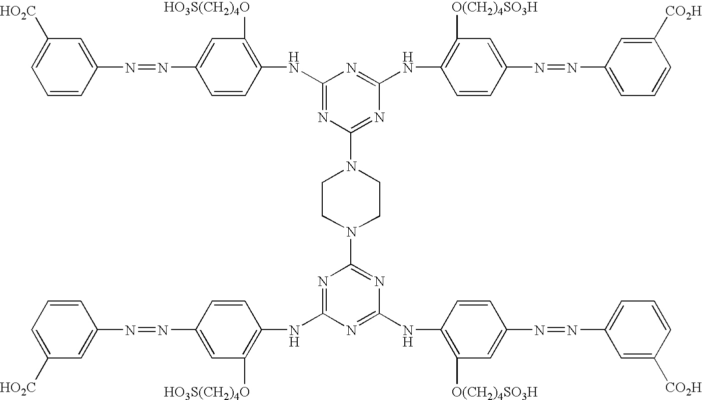 |
| 13 | 1 | 3 | Formula (3) | 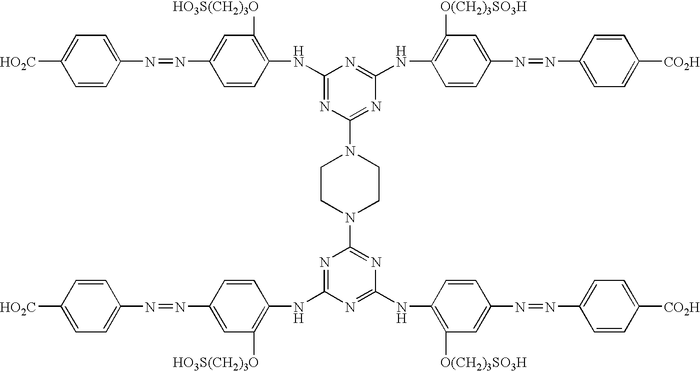 |
| 14 | 1 | 3 | Formula (3) | 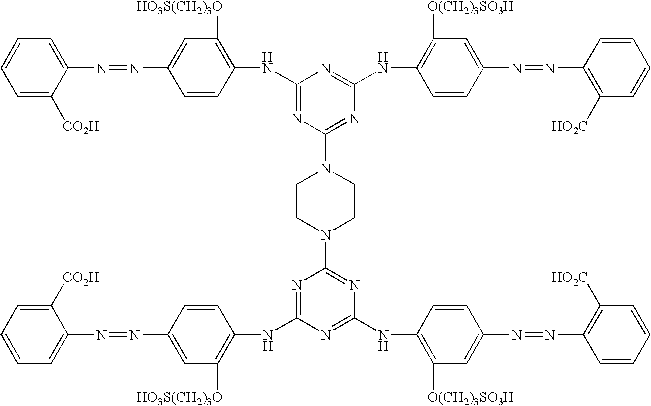 |
| 15 | 2 | 3 | Formula (3) | 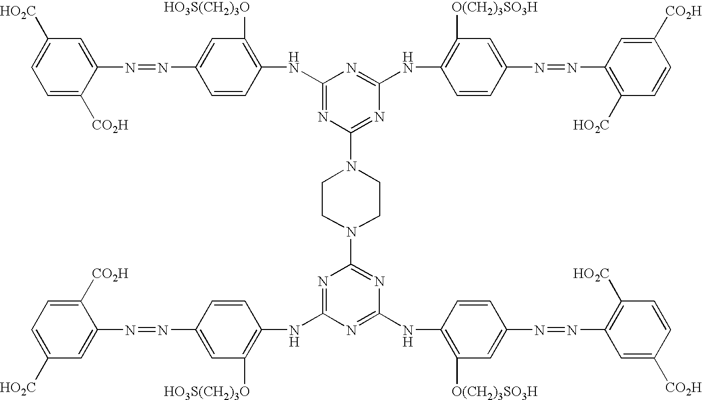 |
| 16 | 2 | 3 | Formula (3) | 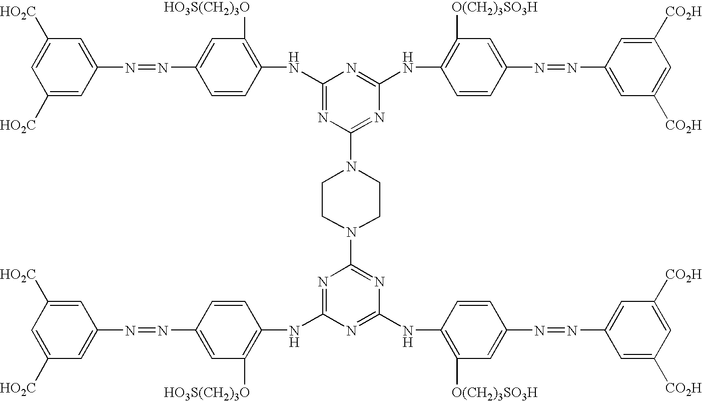 |
| 17 | 1 | 2 | Formula (4) W = 4 | 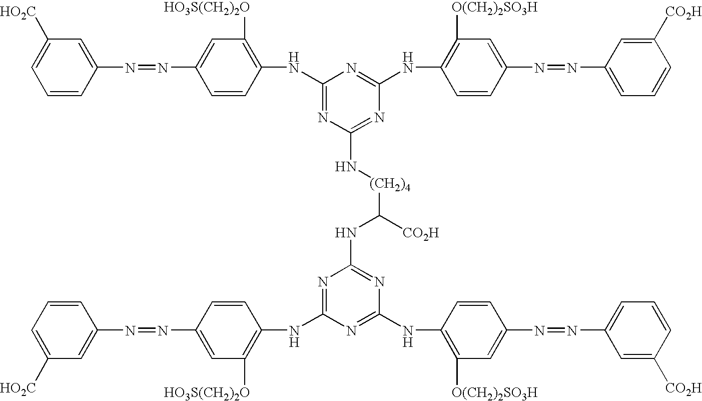 |
| 18 | 1 | 3 | Formula (4) W = 4 | 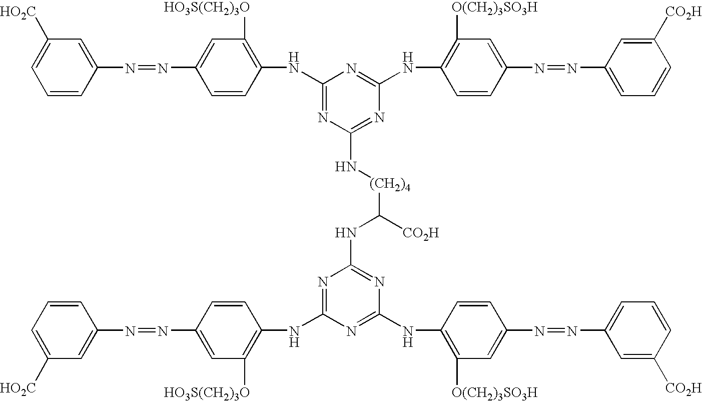 |
| 19 | 1 | 4 | Formula (4) W = 4 | 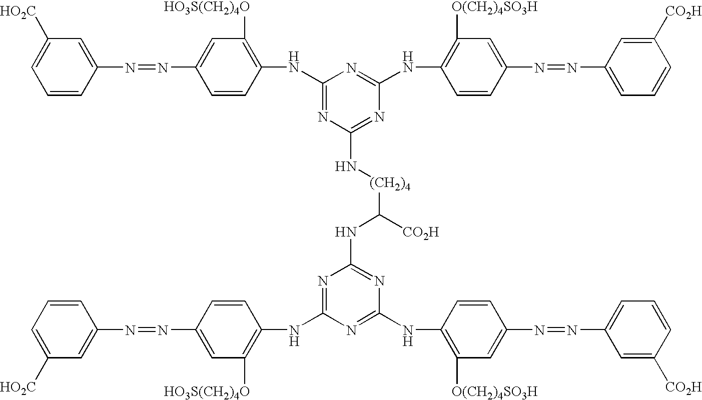 |
| 20 | 1 | 3 | Formula (4) W = 4 | 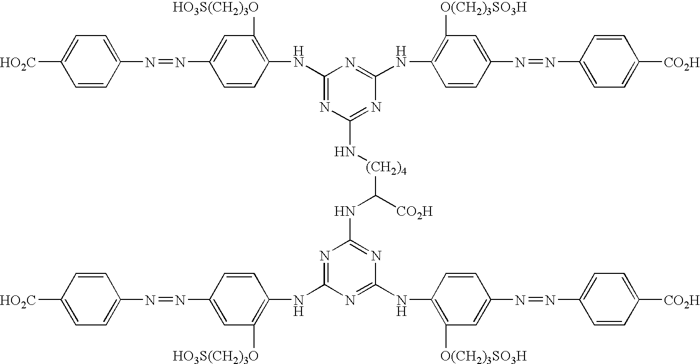 |
| 21 | 1 | 3 | Formula (4) W = 4 | 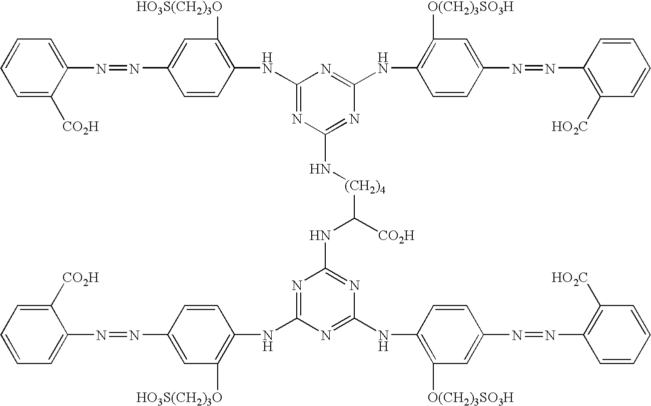 |
| 22 | 2 | 3 | Formula (4) W = 4 | 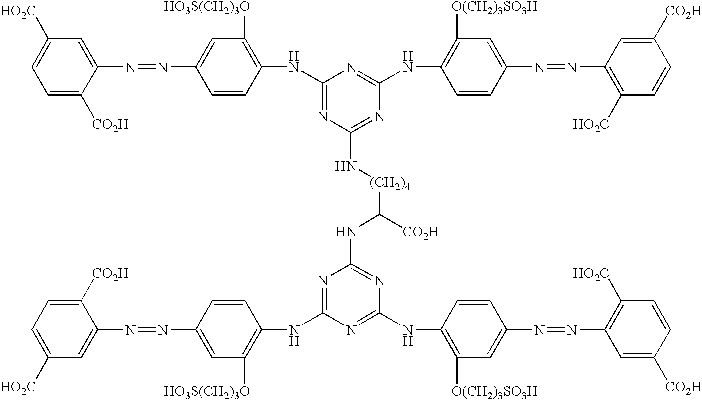 |
| 23 | 2 | 3 | Formula (4) W = 4 | 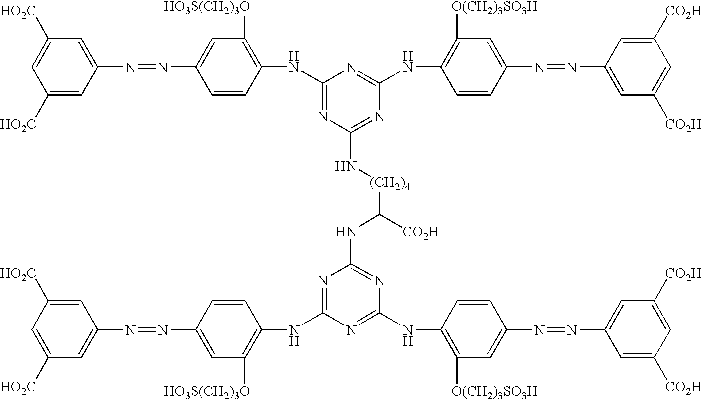 |
| 24 | 1 | 3 | Formula (4) W = 3 | 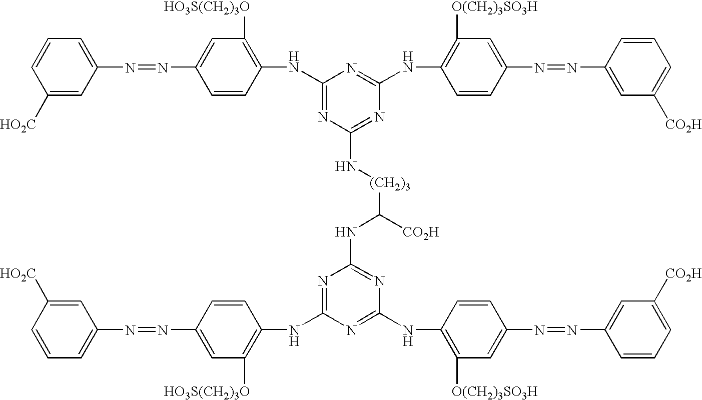 |
| 25 | 1 | 3 | Formula (4) W = 2 | 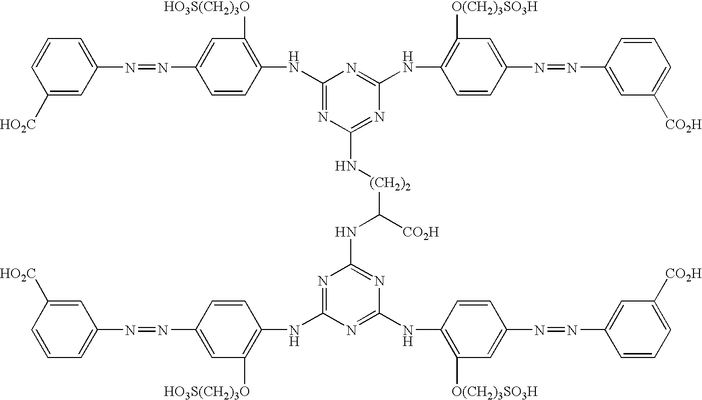 |
| 26 | 1 | 3 | Formula (4) W = 1 | 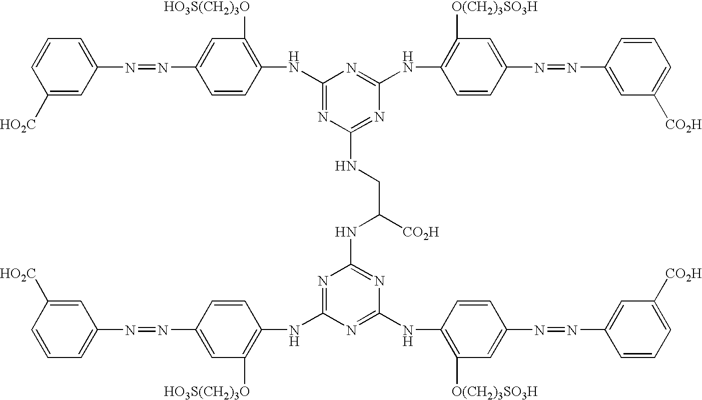 |

The coloring matter of the above formula (1) of the present invention can be isolated as a solid free acid by addition of a mineral acid such as hydrochloric acid after the coupling reaction, and inorganic salts contained as impurities, for example, sodium chloride, sodium sulfate and the like can be removed off by washing the obtained free acid solid with water or acid water, for example, hydrochloric acid-water and the like.

As for the free acid of the coloring matter of the present invention obtained as described above, by treating the obtained wet cake with a desired inorganic or organic base in water as described above, a solution of the corresponding salt of the coloring matter can be obtained, and it is possible to use an aqueous medium instead of water when a solution of the coloring matter of, in particular, an ink for inkjet is made. In this connection, “aqueous medium” usually means a mixed solution of water-soluble organic solvent and water. However, a compound can be used as a medium for the above base treatment if it is made into an aqueous solution by mixing with water, improves dye solubility and does not impair the ink composition of the present invention, for example, such as urea and the like, even though it is not usually classified into an organic solvent. Therefore, when “aqueous medium” is noted in the present description, it includes an aqueous solution of such a substance. Incidentally, urea is generally classified as a dye dissolving agent in ink compositions.

The inorganic base includes, for example, alkali metal hydroxides such as lithium hydroxide, sodium hydroxide and potassium hydroxide, or alkali metal carbonates such as lithium carbonate, sodium carbonate and potassium carbonate, and ammonium hydroxides.

Examples of the organic base include organic amine salts represented by the above formula (6), for example, alkanolamine salts such as diethanolamine and triethanolamine, but not limited thereto.

The coloring matter of the present invention is suitable for dyeing natural and synthetic textiles or textile blends, and in addition, for production of an ink for writing and an ink composition for inkjet recording.

A reaction liquid containing the coloring matter of the above formula (1) of the present invention (for example, reaction liquid before putting 800 parts of acetone in Example 1 described later) can be also used directly for production of the ink composition of the present invention. However, it is also possible that after isolating said compound from the reaction liquid, for example, isolating said compound by drying the reaction liquid and the like by a method such as spray-drying, the obtained compound can be processed into an ink composition. The ink composition of the present invention contains the coloring matter of the above formula (1) in an amount of usually 0.1 to 20% by mass, more preferably 1 to 10% by mass and further preferably 2 to 8% by mass, in the aqueous solution thereof.

The ink composition of the present invention is a composition where the coloring matter of the above formula (1) is dissolved in an aqueous medium such as water and/or a water-soluble organic solvent (water-miscible organic solvent), and according to necessity, an ink preparation agent is added. When this ink composition is used as an ink for inkjet printer, it is preferable to use the compound containing less content of inorganic substances such as metal cation chloride, for example sodium chloride, and sulfuric acid salt, for example sodium sulfate, which are contained as impurities. In this case, the total content of, for example, sodium chloride and sodium sulfate is about 1% by mass or less in the coloring matter. In order to produce the coloring matter containing a smaller amount of inorganic substances, desalting treatment may be carried out by, for example, a known method per se using a reverse osmosis membrane, or by such a method that a dried form or a wet cake of the compound of the present invention or a salt thereof is stirred and purified by suspension in a mixed solvent of C1 to C4 alkanol such as methanol and the like with water, and the solid is separated by filtration and dried.

The ink composition of the present invention is prepared with water as a medium, and according to necessity, may contain a water-soluble organic solvent within the range that the effect of the present invention is not impaired. The water-soluble organic solvent can play a role of a dye dissolving agent, a drying preventive agent (wetting agent), a viscosity modifier, a penetration enhancer, a surface tension modifier, an antifoaming agent and the like, and is used mainly as a drying preventive agent (wetting agent). The other ink preparation agents includes, for example, known additives such as antiseptic and fungicide, pH adjuster, chelating agent, rust preventive agent, ultraviolet absorbing agent, viscosity modifier, dye dissolving agent, antifading agent, emulsion stabilizer, surface tension modifier, antifoaming agent, dispersing agent and dispersion stabilizer. The content of the water-soluble organic solvent is 0 to 60% by mass and preferably 10 to 50% by mass relative to the whole ink, and it is good to use ink preparation agents in an amount of 0 to 20% by mass and preferably 0 to 15% by mass relative to the whole ink. The rest other than the above is water.

The above water-soluble organic solvent includes, for example, C1 to C4 alkanols such as methanol, ethanol, n-propanol, isopropanol, n-butanol, isobutanol, secondary butanol and tertiary butanol; amides such as N,N-dimethylformamide or N,N-dimethylacetoamide; heterocyclic ketones such as 2-pyrrolidone, N-methyl-2-pyrrolidone, hydroxyethyl-2-pyrrolidone, 1,3-dimethylimidazolidin-2-one or 1,3-dimethylhexahydropyrimid-2-one; ketones or keto alcohols such as acetone, methyl ethyl ketone and 2-methyl-2-hydroxypentan-4-one; cyclic ethers such as tetrahydrofuran and dioxane; mono-, oligo- or polyalkylene glycols or thioglycols having a (C2 to C6) alkylene unit such as ethylene glycol, 1,2- or 1,3-propylene glycol, 1,2- or 1,4-butylene glycol, 1,6-hexylene glycol, diethylene glycol, triethylene glycol, tetraethylene glycol, dipropylene glycol, polyethylene glycol, polypropylene glycol or thiodiglycol; polyols (preferably triols) such as glycerine and hexane-1,2,6-triol; polyhydric alcohol (C1 to C4) monoalkyl ethers such as ethylene glycol monomethyl ether, ethylene glycol monoethyl ether, diethylene glycol mono methyl ether, diethylene glycol monoethyl ether, diethylene glycol mono butyl ether (butyl carbitol), triethylene glycol monomethyl ether and triethylene glycol monoethyl ether; gamma-butyrolactone or dimethylsulfoxide; and the like.

Preferable as the above water-soluble organic solvent are isopropanol, glycerine, mono-, di- or triethylene glycol, dipropylene glycol, 2-pyrrolidone, N-methyl-2-pyrrolidone and butyl carbitol, and more preferable are isopropanol, glycerine, diethylene glycol, 2-pyrrolidone, N-methyl-2-pyrrolidone and butyl carbitol. These water-soluble organic solvents are used alone or as a mixture thereof.

The above antiseptic and fungicide includes, for example, compounds of organic sulfur-based, organic nitrogen sulfur-based, organic halogen-based, haloallyl sulfone-based, iodopropargyl-based, N-haloalkylthio-based, benzothiazole-based, nitrile-based, pyridine-based, 8-oxyquinoline-based, isothiazoline-based, dithiol-based, pyridineoxide-based, nitropropane-based, organic tin-based, phenol-based, quaternary ammonium salt-based, triazine-based, thiadiazine-based, anilide-based, adamantane-based, dithiocarbamate-based, brominated indanone-based, benzyl bromoacetate-based, inorganic salt-based and the like.

The organic halogen-based compound includes, for example, sodium pentachlorophenol, the pyridineoxide-based compound includes, for example, sodium 2-pyridinethiol-1-oxide, and the isothiazoline-based compound includes, for example, 1,2-benzisothiazolin-3-one, 2-n-octyl-4-isothiazolin-3-one, 5-chloro-2-methyl-4-isothiazolin-3-one, 5-chloro-2-methyl-4-isothiazolin-3-one magnesium chloride, 5-chloro-2-methyl-4-isothiazolin-3-one calcium chloride, 2-methyl-4-isothiazolin-3-one calcium chloride and the like.

The other antiseptic and fungicides includes sodium acetate, sodium sorbate, sodium benzoate and the like. Other specific examples of the antiseptic and fungicides preferably include Proxel GXL(S), Proxel XL-2(S) and the like which are trade names and manufactured by Avecia Corp.

As the pH adjuster, any substance can be used as long as it can control the pH of the ink in the range of 6.0 to 11.0 for the purpose of improving the storage stability of the ink. Examples thereof include alkanolamines such as diethanolamine and triethanolamine; alkali metal hydroxides such as lithium hydroxide, sodium hydroxide and potassium hydroxide; ammonium hydroxide; alkali metal carbonates such as lithium carbonate, sodium carbonate and potassium carbonate; or the like.

The chelating agent includes, for example, sodium ethylenediaminetetraacetate, sodium nitrilotriacetate, sodium hydroxyethylethylenediamine triacetate, diethylenetriamine sodium pentaacetate, sodium uracil diacetate and the like.

The rust preventive agent includes, for example, hydrogen sulfite salt, sodium thiosulfate, ammonium thioglycolate, diisopropylammonium nitrite, pentaerythritol tetranitrate, dicyclohexylammonium nitrite and the like.

As the ultraviolet absorbing agent, a compound absorbing ultraviolet rays and radiates fluorescence, so called fluorescent brightening agent, as typified by a benzophenone-based compound, a benzotriazole-based compound, a cinnamic acid-based compound, a triazine-based compound, a stilbene-based compound or a benzoxazole-based compound can be also used.

The viscosity modifier includes a water-soluble organic solvent, and in addition, a water-soluble polymer compound, for example, polyvinyl alcohol, cellulose derivatives, polyamines, polyimines and the like.

The dye dissolving agent includes, for example, urea, epsilon-caprolactam, ethylene carbonate and the like. It is preferred to use urea.

The antifading agent is used for the purpose of improving the storage stability of images. As the antifading agent, various organic-based and metal complex-based antifading agents can be used. The organic antifading agent includes hydroquinones, alkoxyphenols, dialkoxyphenols, phenols, anilines, amines, indanes, chromans, alkoxyanilines, heterocycles and the like, and the metal complex includes nickel complex, zinc complex and the like.

The surface tension modifier includes surfactants, for example, anionic surfactant, amphoteric surfactant, cationic surfactant, nonionic surfactant and the like.

The anionic surfactant includes alkylsulfocarboxylate, alpha-olefin sulfonate, polyoxyethylene alkyl ether acetate, N-acylamino acid and a salt thereof, N-acylmethyltaurine salt, alkylsulfate polyoxyalkyl ether sulfate, alkylsulfate polyoxyethylene alkyl ether phosphate, rosin acid soap, castor oil sulfate, lauryl alcohol sulfate, alkylphenol type phosphate ester, alkyl type phosphate ester, alkylallylsulfonate, diethyl sulfosuccinate, diethylhexyl sulfosuccinate, dioctyl sulfosuccinate and the like.

The cationic surfactant includes 2-vinylpyridine derivatives, poly(4-vinylpyridine) derivatives and the like.

The amphoteric surfactant includes lauryldimethylaminoacetic acid betaine, 2-alkyl-N-carboxymethyl-N-hydroxyethyl imidazolinium betaine, coconut oil fatty acid amide propyldimethylaminoacetic acid betaine, polyoctylpolyaminoethylglycine, and in addition, imidazoline derivatives and the like.

The nonionic surfactant includes ether type such as polyoxyethylene nonylphenyl ether, polyoxyethylene octylphenyl ether, polyoxyethylene dodecylphenyl ether, polyoxyethylene octylphenyl ether, polyoxyethylene oleyl ether, polyoxyethylene lauryl ether and polyoxyethylene alkyl ether; ester type such as polyoxyethylene oleate ester, polyoxyethylene distearate ester, sorbitan laurate, sorbitan monostearate, sorbitan monooleate, sorbitan sesquioleate, polyoxyethylene monooleate and polyoxyethylene stearate; acetylene glycol (alcohol) type such as 2,4,7,9-tetramethyl-5-decyne-4,7-diol, 3,6-dimethyl-4-octyne-3,6-diol and 3,5-dimethyl-1-hexyn-3-ol (for example, Surfynol 104, 82 and 465, Olfine STG and the like which are trade names and manufactured by Nissin Chemical Industry Co., Ltd.); and the like.

As the antifoaming agent, highly oxidized oil-based, glycerin fatty acid ester-based, fluorine-based and silicone-based compounds are used according to necessity.

These ink preparation agents are used alone or as a mixture thereof. In this connection, the surface tension of the ink of the present invention is usually 25 to 70 mN/m and more preferably 25 to 60 mN/m. In addition, the viscosity of the ink of the present invention is preferably 30 mPa·s or less. Further, it is more preferred to adjust to 20 mPa·s or less

In production of the ink composition of the present invention, the order of dissolving agents such as additives is not particularly limited. In preparation of the ink, as water to be used, water with less impurity such as ion-exchanged water or distilled water is preferable. In addition, microfiltration may be, according to necessity, carried out using a membrane filter to remove foreign substances away, and it is preferred to carry out microfiltration in the case of using as an ink for inkjet printer. The pore size of a filter with which microfiltration is carried out is usually 1 micron to 0.1 micron, preferably 0.8 micron to 0.2 micron.

The ink composition containing the coloring matter of the present invention is suitable for use in impress printing, copying, marking, writing, drafting, stamping or recording (printing), particularly in inkjet recording. In addition, as for the ink composition of the present invention, crystal precipitation hardly occurs in spite of the dryness in vicinity of the nozzle in an inkjet printer, and for this reason, clogging at the head also hardly occurs. Further, when the ink composition of the present invention is used for inkjet recording, high quality yellow printed matters having a good fastness against water, light, ozone or nitrogen oxide gas and friction can be obtained and the water fastness thereof on plain paper is extremely good.

For the purpose of providing high resolution images by an inkjet printer, some printers respectively comprise two kinds of inks, a high concentration ink and a low concentration ink, in one printer. In that case, an ink composition having a high concentration and an ink composition having a low concentration are respectively produced using the coloring matter of the present invention and they may be used as an ink set. Or said coloring matter may be used for either thereof. Alternatively, the coloring matter of the present invention may be used in combination with a known yellow coloring matter. Otherwise, the coloring matter of the present invention can be used for color toning of other colors, for example black ink, or for the purpose of preparing red ink or green ink by mixing with a magenta coloring matter or a cyan coloring matter.

The colored product of the present invention is a substance colored with the coloring matter of the present invention. The materials of the colored product are not limited, and any may be used as long as they can be colored, for example, communication sheets such as paper and film, fiber and cloth (such as cellulose, nylon and wool), leather, substrates for a color filter, and the like, and it is not limited thereto. The coloring method includes, for example, printing methods such as dip dyeing, textile printing and screen printing, a method by an inkjet printer, and the like, and the method by inkjet printer is preferable.

The communication sheet is not particularly limited, and sheets subjected to surface treatment, specifically paper, synthetic paper, film and the like whose substrate is provided with an ink receiving layer are used, not to mention plain paper. The ink receiving layer herein is a layer having a function of absorbing ink and accelerating drying, and the like, and it is mounted by, for example, a method of impregnating or coating cation polymer on the above substrate; a method of coating inorganic particles capable of absorbing coloring matter in ink, such as porous silica, aluminasol and special ceramics, on the above substrate surface together with a hydrophilic polymer such as polyvinyl alcohol and polyvinylpyrrolidone; or the like. The sheet provided with such an ink receiving layer is usually called inkjet special paper, inkjet special film, glossy paper, glossy film or the like.

Plain paper means a paper not particularly provided with any ink receiving layer, and a lot of various plain papers are commercially available according to the application. For an instance of plain paper commercially available, the plain paper for inkjet includes both sides-high quality plain paper (manufactured by Seiko-Epson Corporation), color plain paper (manufactured by Canon Inc.), Multipurpose Paper and All-in-one Printing Paper (manufactured by Hewlett Packard) and the like. In addition to these, paper for plain paper copy (PPC) and the like whose application is not particularly limited to inkjet printing is also a plain paper.

The ink composition of the present invention is particularly excellent in water fastness on plain paper as described above and also excellent in other fastnesses against light, ozone, humidity, friction and the like. In addition, it is also excellent in water fastness, light fastness, gas fastness, moisture fastness, abrasion resistance and the like and very excellent particularly in water fastness, on communication sheets such as inkjet special paper, special film, glossy paper, glossy film or the like provided with an ink receiving layer for inkjet printing.

In order to record on a record-receiving material by the inkjet recording method of the present invention, for example, a container filled with the above ink composition is placed in the predetermined position of an inkjet printer and recording is performed on a record-receiving material by an ordinary method. In the inkjet recording method of the present invention, inks of colors such as magenta, cyan, and according to necessity, green, blue (or violet), red, black and the like can be used in combination together with the ink composition of the present invention. In this case, inks are poured respectively into a container and those containers are placed in the predetermined positions of an inkjet printer for use.

The inkjet printer includes, for example, printers using a piezo system utilizing mechanical vibration, a bubble jet (registered trademark) system utilizing bubbles generated by heating, and such a system. In the inkjet recording method of the present invention, any system can be used.

The ink composition of the present invention is vivid yellow, allows a high color definition of images recorded therewith on plain paper, inkjet special paper and glossy paper, and has a hue suitable for the inkjet recording method. In addition, it is characterized by the very high fastness of recorded images.

The ink composition of the present invention is free from precipitation and separation during storage. When the ink composition of the present invention is used for inkjet recording, crystal precipitation due to drying of the ink composition in vicinity of the nozzle very hardly occurs and thus the injector (ink head) is not clogged. The ink composition of the present invention has no change in its physical properties even in the case of use by recirculating ink at relatively long time intervals using a continuous ink jet printer or also in intermittent use by an on-demand printer.

### EXAMPLE

Hereinafter, the present invention will be more specifically explained with reference to Examples. In this connection, “part(s)” and “%” described here is based on mass unless otherwise specifically noted, and “reaction temperature” means “internal temperature”.

In addition, for λmax (maximum absorption wavelength) of each compound synthesized, each value measured in an aqueous solution at pH 7 to 8 is shown. Further, examples of sodium salt or ammonium salt are only described in Examples, but an alkali metal salt, a salt with an organic cation, and the like can be easily obtained by using an appropriate method; and the present invention is not limited to the present Examples.

Furthermore, in the structural formula of each compound obtained in Examples, groups such as carboxy and sulfo are shown in free acid form. Moreover, superscript RTM stands for registered trademark.

### Example 1

In 200 parts of water, 13.7 parts of 3-aminobenzoic acid is dissolved while adjusting to pH 6 with sodium hydroxide, and then 7.2 parts of sodium nitrite was added thereto. After this solution was added dropwise to 300 parts of 5% hydrochloric acid at 0 to 10° C. over 30 minutes, the mixture was stirred at 10° C. or less for 1 hour for diazotization reaction to prepare a diazonium salt.

Meanwhile, in 130 parts of water, 23.1 parts of 2-sulfopropoxyaniline was dissolved while adjusting to pH 5 with sodium hydroxide, and then the resulting was converted to methyl-ω-sulfonic acid derivative by a conventional method using 10.4 parts of sodium bisulfite and 8.6 parts of 35% formalin.

The obtained methyl-ω-sulfonic acid derivative was added to the diazonium salt prepared in advance and the mixture was stirred at 0 to 15° C. and pH 6 to 7 for 5 hours. After the reaction liquid was adjusted to pH 11 with sodium hydroxide, it was stirred at 80 to 95° C. for 5 hours while maintaining the same pH. Next, 100 parts of sodium chloride was added thereto for salting out and the precipitated solid was separated by filtration, whereby 100 parts of an azo compound of the formula (7) as a wet cake.

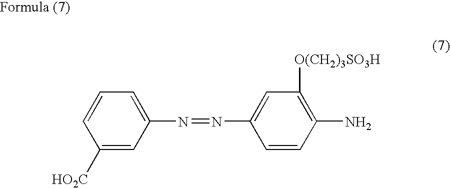

Next, 100 parts of the wet cake of the obtained azo compound was dissolved in 300 parts of water. To this solution, 0.10 part of surfactant (manufactured by Lion Corporation; trade name: LEOCOL® TD50) was added followed by stirring, subsequently 6.4 parts of cyanuric chloride was added, and after that, the mixture was stirred at pH 5 to 7.5 and 25 to 45° C. for 6 hours.

Next, 1.1 parts of ethylenediamine was added thereto and the resulting mixed liquid was stirred at pH 7 to 9 and 75 to 90° C. for 3 hours. After the resulting reaction liquid was cooled to 20 to 40° C., 800 parts of acetone was added to this reaction liquid and the mixture was stirred at 20 to 40° C. for 1 hour. The precipitated solid was separated by filtration, whereby 150 parts of a wet cake was obtained. This wet cake was dried at 80° C. with a hot air dryer to obtain 28.0 parts of a water-soluble azo compound of the present invention represented by the following formula (8) (λmax 384 nm) was obtained as a sodium salt.

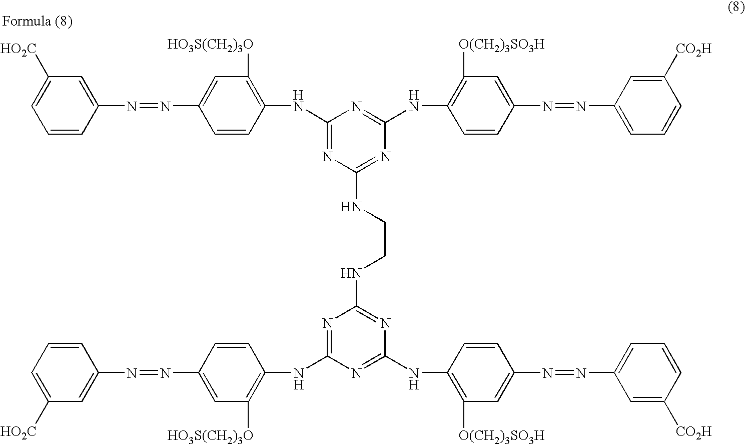

### Example 2

In the same manner as in Example 1 except that 3.0 parts of piperazine was used instead of 1.1 parts of ethylenediamine in Example 1, 29.0 parts of a water-soluble azo compound of the present invention represented by the following formula (9) (λmax 388 nm) was obtained as a sodium salt.

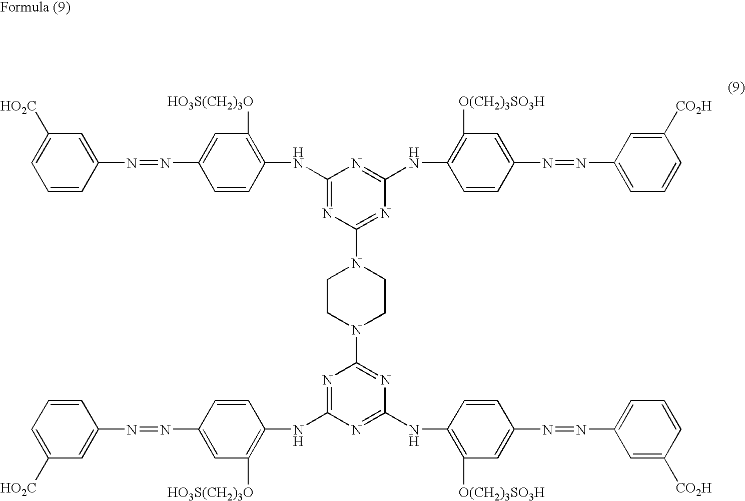

### Example 3

In the same manner as in Example 1 except that 5.1 parts of 2,6-diaminohexanoic acid was used instead of 1.1 parts of ethylenediamine in Example 1, 30.0 parts of a water-soluble azo compound of the present invention represented by the following formula (10) (λmax 392 nm) was obtained as a sodium salt.

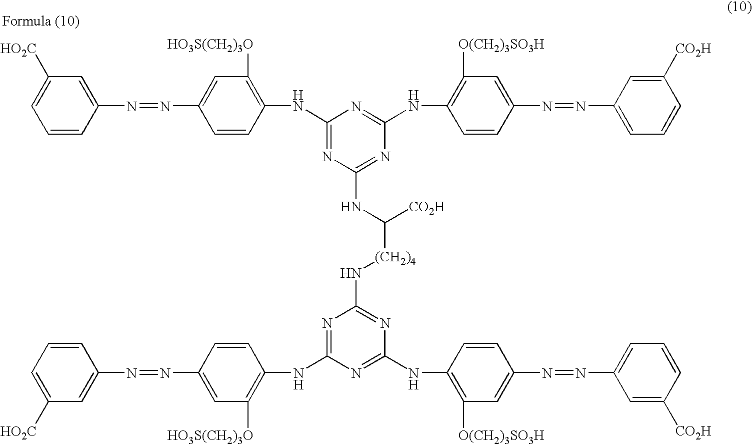

### Example 4

In 270 parts of water, 29.0 parts of the water-soluble azo compound of the present invention represented by the above formula (9) obtained in Example 2 was dissolved. Thereto, 45 parts of ammonium chloride was added, and after that, the mixture was adjusted to pH 1 to 3 with hydrochloric acid and stirred for 30 minutes, and the precipitated solid was separated by filtration. By this treatment, salt exchange from sodium salt to ammonium salt was done and 120 parts of a wet cake of an ammonium salt was obtained. After this wet cake was washed with 200 parts of methanol, the wet cake was dried at 80° C. with a hot air dryer to obtain 25.0 parts of an ammonium salt of the water-soluble azo compound of the present invention represented by the above formula (9) (λmax 388 nm).

### Example 5 to 7

### (A) Preparation of Ink

### (i) Examples 5 and 6

By using each of the azo compounds (sodium salts of the formula (8) and the formula (9)) obtained in the above Examples 1 and 2 and by mixing at the composition ratio shown in Table 2, each ink composition of the present invention was obtained. The obtained ink compositions were respectively filtered using a 0.45 μm membrane filter to remove foreign substances, and inks containing each compound were prepared. The ink using the azo compound of Example 1 is Example 5 and the ink using the azo compound of Example 2 is Example 6.

In this connection, ion-exchanged water is used as water, the pH of the ink compositions was adjusted to about 9.5 with an aqueous sodium hydroxide solution, and then water was added to make the total amount 100 parts.

TABLE 2
(Composition ratio of ink composition)

| | | |
|---|---|---|
| Azo compound obtained in Example 1 or 2 | 4.0 | parts |
| Glycerine | 5.0 | parts |
| Urea | 5.0 | parts |
| N-methyl-2-pyrrolidone | 4.0 | parts |
| Isopropylalcohol | 3.0 | parts |
| Butyl carbitol | 2.0 | parts |
| Trade name: Surfynol 104PG50 (Note) | 0.1 | part |
| Sodium hydroxide + water | 76.9 | parts |
| Total | 100.0 | parts |

(Note)
Acetylene glycol nonionic surfactant manufactured by Nissin Chemical Industry Co., Ltd.

### (ii) Example 7

By using the azo compound (ammonium salt of the formula (10)) obtained in the above Example 4 and by mixing at the composition ratio shown in Table 3, an ink composition of the present invention was obtained. The obtained ink composition was filtered using a 0.45 μm membrane filter to remove foreign substances, and an ink containing the above azo compound was prepared. This ink is Example 7.

In this connection, ion-exchanged water is used as water, the pH of the ink composition was adjusted to about 9.5 with an ammonia water solution, and then water was added to make the total amount 100 parts.

TABLE 3
(Composition ratio of ink composition)

| | | |
|---|---|---|
| Azo compound obtained in Example 4 | 4.0 | parts |
| Glycerine | 5.0 | parts |
| Urea | 5.0 | parts |
| N-methyl-2-pyrrolidone | 4.0 | parts |
| Isopropylalcohol | 3.0 | parts |
| Butyl carbitol | 2.0 | parts |
| Trade name: Surfynol 104PG50 (Note) | 0.1 | part |
| Ammonia water + water | 76.9 | parts |
| Total | 100.0 | parts |

(Note)
Acetylene glycol nonionic surfactant manufactured by Nissin Chemical Industry Co., Ltd.

### Comparative Example 1

An ink for comparison was prepared following the same procedure and in the same ratio as in Table 3, using, as a coloring matter component, the coloring matter described in Example 10 of Patent Literature 1 instead of the azo compound obtained in Example 4. The structural formula of the compound used is shown in the following formula (11). In this connection, evaluation was conducted using an ammonium salt of the following formula (11).

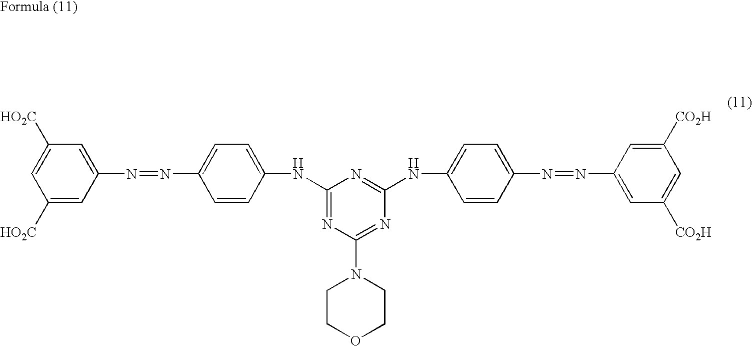

### (B) Inkjet Printing

Using an inkjet printer (manufactured by Canon Inc.; trade name: PIXUS ip 4100), inkjet recording was performed on the five kinds of plain papers shown in Table 4 below.

Inkjet recording was performed using two kinds of patterns described below.

(i) In inkjet recording, a checked pattern (where 1.5 mm squares having a density of 100% and 1.5 mm squares having a density of 0% were alternately placed) was made, and a high contrast yellow/white printed matter was obtained. In this connection, the white part was the surface of a plain paper which was uncolored with ink.
(ii) An image pattern was so made that a gradation of several stages is obtained in its reflection density, and a gradation printed matter having a yellow density gradation was obtained.

When judgment by visual observation was carried out in water fastness test, the printed matters of the checked pattern were used.

For measurement of the residual rate of coloring matter in water fastness test, measurement of reflection density was carried out on the part where the reflection density, D value, of each printed matter before the test was the closest to 1, using the gradation printed matter. In addition, the reflection density was measured using a colorimetric system (trade name: SpectroEye, manufactured by GretagMacbeth).

The evaluation of the recorded images (C), the water fastness test method of the recorded images and evaluation methods of the test results (D) to (F), and the evaluation result (Table 10) are described below the following Table 4.

TABLE 4

Plain paper 1:
Manufactured by Canon Inc.
Trade name: LBP PAPER LS-500
Plain paper 2:
Manufactured by Hewlett Packard
Trade name: Multipurpose Paper
Plain paper 3:
Manufactured by Hewlett Packard
Trade name: All-in-One Printing Paper
Plain paper 4:
Manufactured by Seiko-Epson Corporation
Both sides-high quality plain paper KA4250NPD
Plain paper 5:
Manufactured by Canon Inc.
Color plain paper LC-301

### (C) Evaluation of Recorded Image

For evaluation of the recorded images, measurement of brightness L*, color saturation C* and hue angle h of each printed matter was carried out.

Using the above colorimetric system, brightness L* value, color saturation C* value and hue angle h value of the part where the yellow reflection density, Dy value, was the closest to 1.0 in the printed matter of the printed gradation were measured. The result of plain paper 1 is shown in Table 5, the result of plain paper 2 is shown in Table 6, the result of plain paper 3 is shown in Table 7, the result of plain paper 4 is shown in Table 8, and the result of plain paper 5 is shown in Table 9, respectively.

As for color saturation C* in Tables 5 to 9, the C* values of Examples 5 to 7 are clearly higher than that of Comparative Example in any plain paper, whereby it is found that the coloring matter of the present invention is a coloring matter having a high color saturation.

TABLE 5
Plain paper 1

| | L* | C* | h |
|---|---|---|---|
| Example 5 | 87.2 | 72.3 | 95.3 |
| Example 6 | 86.7 | 72.3 | 93.6 |
| Example 7 | 87.6 | 73.5 | 93.8 |
| Comparative Example 1 | 88.8 | 68.0 | 97.8 |

TABLE 6
Plain paper 2

| | L* | C* | h |
|---|---|---|---|
| Example 5 | 89.5 | 72.2 | 93.6 |
| Example 6 | 88.9 | 69.8 | 92.8 |
| Example 7 | 88.8 | 71.0 | 92.0 |
| Comparative Example 1 | 90.3 | 69.1 | 97.4 |

TABLE 7
Plain paper 3

| | L* | C* | h |
|---|---|---|---|
| Example 5 | 89.4 | 72.3 | 93.7 |
| Example 6 | 89.3 | 70.9 | 92.7 |
| Example 7 | 88.4 | 72.0 | 92.0 |
| Comparative Example 1 | 90.9 | 69.4 | 96.9 |

TABLE 8
Plain paper 4

| | L* | C* | h |
|---|---|---|---|
| Example 5 | 85.3 | 67.4 | 95.3 |
| Example 6 | 85.6 | 65.1 | 94.8 |
| Example 7 | 85.2 | 65.6 | 94.5 |
| Comparative Example 1 | 86.9 | 63.3 | 98.1 |

TABLE 9
Plain paper 5

| | L* | C* | h |
|---|---|---|---|
| Example 5 | 89.4 | 70.5 | 97.8 |
| Example 6 | 89.6 | 70.5 | 97.7 |
| Example 7 | 88.8 | 72.4 | 97.0 |
| Comparative Example 1 | 89.4 | 62.4 | 99.5 |

### (D) Water Fastness Test 1

### Evaporative Drying Test

On the printed matter of checked pattern which had been dried for 24 hours after printing, one drop of ion-exchanged water was put, and the printed matter was left dry naturally. After drying, the degree of pattern blurring was evaluated by visual observation and evaluated into 3 ranks according to the following criteria.

| | |
|---|---|
| No blurring (impossible to find where the drop was put) | ◯ |
| Almost no blurring (possible to find the area where the drop was put) | Δ |
| Clearly blurring | X |

The results are shown in Table 10.

### (E) Water Fastness Test 2

### Immersion Test 1

The printed matter of checked pattern which had been dried for 24 hours after printing was immersed in ion-exchanged water for 1 hour. After drying, the degree of discoloring on the colored part of the pattern and the degree of coloring on the white part were evaluated by visual observation, and evaluated into 3 ranks according to the following criteria.

| | |
|---|---|
| No discoloring nor coloring | ◯ |
| Discoloring and coloring are slightly observed | Δ |
| Discoloring and coloring are clearly observed | X |

The results are shown in Table 11.

### (F) Water Fastness Test 3

### Immersion Test 2

The printed matter of gradation which had been dried for 24 hours after printing was immersed in ion-exchanged water for 1 hour. After drying, the reflection density was measured using the above colorimetric system. After the measurement, the residual rate of coloring matter was determined by calculation from (reflection density after the test/reflection density before the test)×100(%), and evaluated into 3 ranks according to the following criteria.

| | |
|---|---|
| Residual rate of coloring matter is 90% or more | ⊚ |
| Residual rate of coloring matter is 80% or more and under 90% | ◯ |
| Residual rate of coloring matter is 50% or more and under 80% | Δ |
| Residual rate of coloring matter is under 50% | X |

The results are shown in Table 12.

TABLE 10
Result of water fastness test 1

| | (P.p. 1) | (P.p. 2) | (P.p. 3) | (P.p. 4) | (P.p. 5) |
|---|---|---|---|---|---|
| Example 5 | Δ | ◯ | ◯ | ◯ | ◯ |
| Example 6 | ◯ | ◯ | ◯ | ◯ | ◯ |
| Example 7 | ◯ | ◯ | ◯ | ◯ | ◯ |
| Comparative Example 1 | Δ | ◯ | ◯ | ◯ | ◯ |

*P.p. means Plain paper

TABLE 11
Result of water fastness test 2

| | (P.p. 1) | (P.p. 2) | (P.p. 3) | (P.p. 4) | (P.p. 5) |
|---|---|---|---|---|---|
| Example 5 | Δ | ◯ | ◯ | Δ | Δ |
| Example 6 | ◯ | ◯ | ◯ | ◯ | ◯ |
| Example 7 | ◯ | ◯ | ◯ | ◯ | ◯ |
| Comparative Example 1 | X | Δ | Δ | X | Δ |

*P.p. means Plain paper

TABLE 12
Result of water fastness test 3

| | (P.p. 1) | (P.p. 2) | (P.p. 3) | (P.p. 4) | (P.p. 5) |
|---|---|---|---|---|---|
| Example 5 | ⊚ | ⊚ | ⊚ | ⊚ | ⊚ |
| Example 6 | ⊚ | ⊚ | ⊚ | ⊚ | ⊚ |
| Example 7 | ⊚ | ⊚ | ⊚ | ⊚ | ⊚ |
| Comparative Example 1 | Δ | ⊚ | ⊚ | ⊚ | ⊚ |

*P.p. means Plain paper

As is clear from the results of Tables 5 to 9, it is found that the inks of Examples 5 to 7 are more excellent in color saturation C* value in any of plain papers 1 to 5 than that of Comparative Example 1 and thus they are inks having a yellow hue having a high color saturation. In addition, it is found that the hue angle does not vary from plain paper to plain paper as a printing object and thus the inks always exhibit highly vivid yellow.

In addition, from the evaluation results of water fastness test 1 in Table 10, it is found that there are differences in plain paper 1 and thus Example 6 and Example 7 have high water fastness. In the present test, the water fastnesses of Example 5 and Comparative Example 1 are almost same.

Judging from the evaluation results of water fastness test 2 in Table 11, the inks of Example 6 and Example 7 show very good water fastness in any of plain papers 1 to 5. In addition, in the present test, it is found that when plain papers 1 to 4 are used, the ink of Example 5 clearly has more excellent water fastness than that of Comparative Example 1.

From the evaluation results of water fastness test 3 in Table 12, it is found that Examples and Comparative Example have the same result in plain papers 2 to 5 but have marked differences in plain paper 1 and thus any of Examples has much better water fastness than Comparative Example 1.

Judging from the above results, the water-soluble azo compound of the present invention is suitable for preparation of ink compositions for inkjet recording, excellent in fastnesses, in particular extremely excellent in water fastness, and high in water-solubility, and has a good and vivid hue. It is clear from these characteristics that the azo compound of the present invention is a very useful compound as an ink coloring matter for various recordings, particularly as a yellow coloring matter for inkjet ink.

1. A water-soluble azo compound represented by the following formula (1) or a salt thereof: 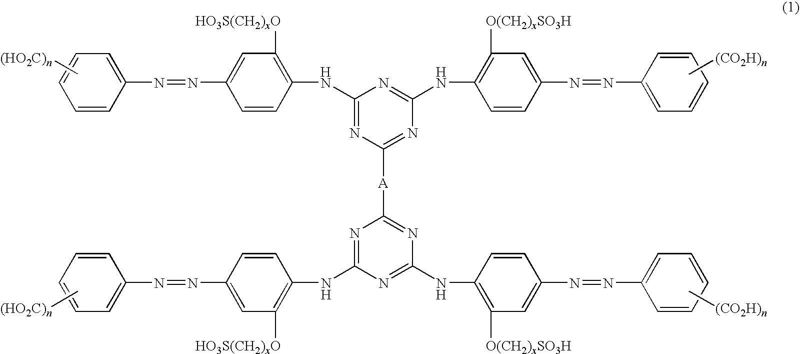
[wherein, n denotes 1 or 2, x denotes 2 to 4, and A denotes a divalent bonding group represented by any one of the following general formulas (2) to (4):
Formulas (2) to (4) 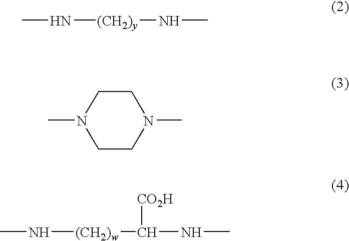
(wherein, y denotes an integer number of 2 to 6, and w denotes an integer number of 1 to 4)]

2. The water-soluble azo compound or a salt thereof according to claim 1 represented by the following formula (5):

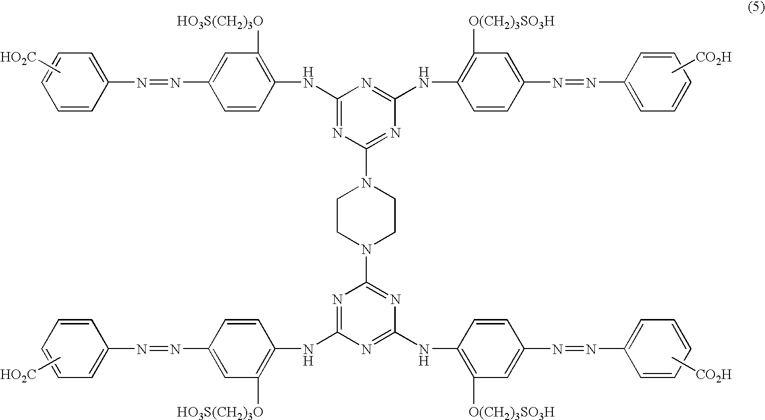

3. An ink composition containing the water-soluble azo compound or a salt thereof according to claim 1 or claim 2.

4. The ink composition according to claim 3, which contains a water-soluble organic solvent.

5. The ink composition according to claim 3 or claim 4, which is for inkjet recording.

6. An inkjet recording method characterized by discharging ink droplets of either (a) an ink composition containing the water-soluble azo compound or a salt thereof according to claim 1 or claim 2 or (b) an ink composition containing both the water-soluble azo compound or a salt thereof according to claim 1 or claim 2 and a water-soluble organic solvent, in response to a recording signal to record on a record-receiving material.

7. The inkjet recording method according to claim 6, wherein the record-receiving material is a communication sheet.

8. The inkjet recording method according to claim 7, wherein the communication sheet is a plain paper or a sheet having an ink receiving layer containing a porous white inorganic substance.

9. A colored product colored with any of (a) the water-soluble azo compound or a salt thereof according to claim 1 or claim 2, or (b) an ink composition containing the water-soluble azo compound or a salt thereof according to claim 1 or claim 2, or (c) an ink composition containing both the water-soluble azo compound or a salt thereof according to claim 1 or claim 2 and a water-soluble organic solvent.

10. The colored product according to claim 9, wherein coloring is performed by an inkjet printer.

11. An inkjet printer comprising a container which is filled with either an ink composition containing the water-soluble azo compound or a salt thereof according to claim 1 or claim 2 or an ink composition containing both the water-soluble azo compound or a salt thereof according to claim 1 or claim 2 and a water-soluble organic solvent.
